(19) United States
(12) Patent Application Publication
(10) Pub. No.: US 2010/0294857 A1
(43) Pub. Date: Nov. 25, 2010

(54) ARRANGEMENT FOR VENTILATING SHOWER STREAMS

(76) Inventor: Jan Heisterhagen, Schutterwald (DE)

Correspondence Address: DUANE MORRIS LLP - Philadelphia;IP DEPARTMENT, 30 SOUTH 17TH STREET, PHILADELPHIA, PA, 19103-4196, US

(21) Appl. No.: 12/744,222

(22) PCT Filed: Nov. 25, 2008
(86) PCT No.: PCT/EP08/09956

§ 371 Date: Aug. 10, 2010

(30) Foreign Application Priority Data
Nov. 27, 2007 (DE) 10 2007 058 259.7

(51) Int. Cl. B05B 1/14

(52) U.S. Cl. 239/311

(57) ABSTRACT

In order to ventilate shower streams exiting from a hand-held shower, the invention proposes disposing a ventilation device not in the hand-held shower itself, but in the shower hose (1) through which the hand-held shower is supplied with water. The invention particularly proposes disposing the ventilation device in the fitting (1, 20, 30) for connecting the shower hose either to the water inlet side or to the hand-held shower. Furthermore, a backflow preventer (13) may be disposed in the ventilation device. The air supply to the ventilation device may be carried out by a channel (12) formed by an intermediate space between the terminal nut (3) and the hose exterior side.

The invention relates to a device for ventilating shower streams.

It has been well known for some time that shower streams are ventilated for visual or for water-saving reasons. Ventilation devices that take in water from outside, based on the streaming water, serve for this purpose.

In overhead showers, connected by means of a ball joint with a fixed installation device, it is common to accommodate a ventilation device inside the fixed installation device. The air is then sucked in from outside at the ball joint itself (U.S. Pat. No. 5,154,335). At this point a gap is formed between a nipple and the actual shower head so that these air inlet openings are practically invisible.

It is also known to attach a pipe-like adapter in which a ventilation device is accommodated (DE 10008438) at the exit of a sanitary fitting.

The problem that basically exists in known solutions is that, in changing flow resistance of the shower, for example through calcification after a longer period of operation, or by means of the connection of showers, which, in their flow and flow resistance, are not adjusted to the ventilation device, the dynamic pressure may become too great. Then the ventilation device not only works longer, but water can also flow out of the ventilation opening.

The attachment of an additional element between the hose pipe and the sanitary fitting changes the optical appearance of the sanitary fitting significantly and is therefore used reluctantly due to aesthetics.

The task of the invention is to propose an arrangement for the ventilation of water streams, especially in a hand-held shower, which does not feature the above-mentioned disadvantages and which is especially suitable for retrofitting without impairing aesthetic aspects.

To solve this task, the invention proposes an arrangement with the features of claim 1. The invention also proposes a shower hose for an arrangement according to claim 1.

In contrast to conventional technology, the ventilation device is integrated now for the first time directly inside the shower hose. The shower hose, by which the connection nipple looks like a common connection nipple does not change the appearance of a sanitary fitting. Therefore, the visual impressions evoked by the sanitary fitting remain preserved. On the other hand, the hose that is provided with a ventilation device makes it possible also to operate such hand-held showers with ventilated streams even if they do not feature a ventilation device. The arrangement can naturally also be used if the hose leads to a fixed shower head that functions as an overhead shower, for example.

In a further embodiment of the invention it can be provided that the ventilation device is disposed in the connection nipple that serves for the water supply to the shower. Such a possibility can for example have an visually impressive effect in transparent shower hoses. Moreover, a ventilation opening can be formed here in a manner such that the handling of the hand-held shower is not impeded.

However, it is also possible and proposed by the invention, to provide the ventilation device in the connection nipple on which the hand-held shower is mounted. It is therefore also possible to provide a ventilation device in both connection nipples.

In a further embodiment of the invention it can be provided that the ventilation device features a ventilation channel guided through the connection nut of the connection nipple formed as a screw connection.

The ventilation channel for example can converge outside the connection nut, thus, as an opening in the jacket surface of the connection nut.

That said, it is also possible for a ventilation channel to be formed for the ventilation device between the outside of the hose and the inside of the connection nut. In this case, no opening of the ventilation channel is visible. An available interstice can be used for this purpose.

In yet another embodiment of the invention it can be provided that the ventilation device features a backflow preventer. This should be accomplished such that, due to a very small flow cross-section, a hand-held shower or an overhead shower that is connected is unsuitable for the shower hose, back pressure could build up and result in water coming out of the ventilation device.

According to the invention it can be provided that the ventilation device is arranged, particularly fitted, as a unit inside the connection. If necessary, it can also be retrofitted in such a connection nipple.

In yet another embodiment of the invention it can be provided that the ventilation device is formed in two parts out of an upper part and a lower part, whereby the backflow preventer is arranged between both parts.

In particular, the lower part can be a single-part component of the nipple that extends inside the hose.

In a further embodiment of the invention it can be provided that the backflow preventer only has an effect on the ventilation device, but not on the stream of water through the shower hose.

In yet another embodiment of the invention it can be provided that a flow limiter is disposed in one of both connection nipples, preferably in the connection nipple assigned to the sanitary fitting.

Further features, details and advantages of the invention result from the claims and the summary, the wording of which is made by reference to the contents of the description, of the following description of preferred embodiments of the invention, as well as on the basis of the drawing. Shown hereby:

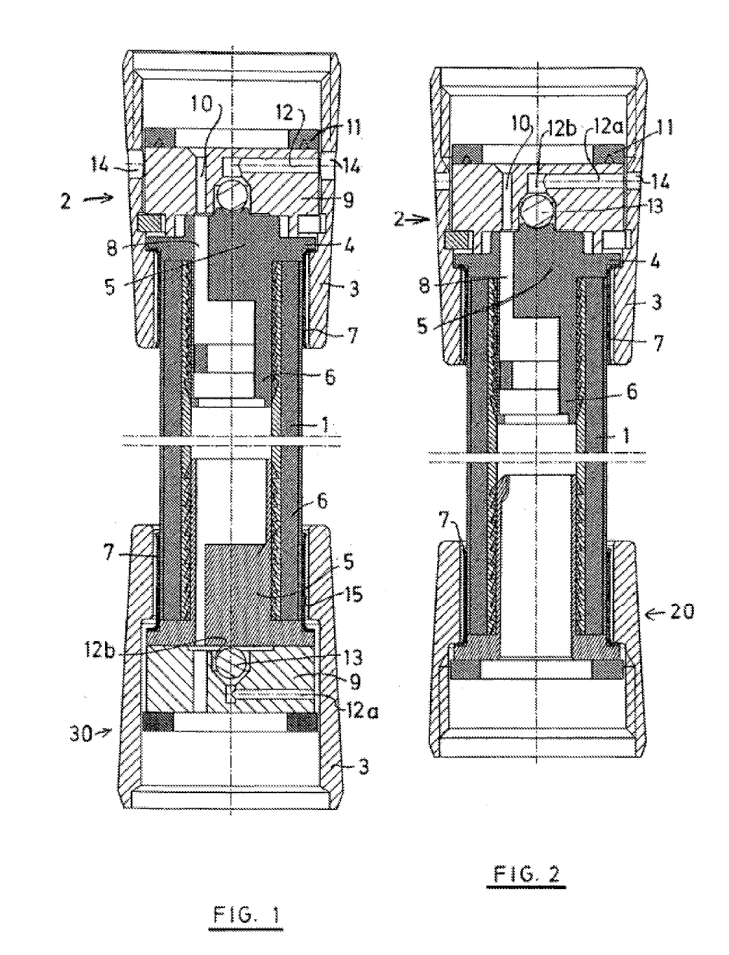

FIG. 1 is an axial section through both ends of a shower hose;

FIG. 2 a section corresponding to FIG. 1 through a further embodiment.

The shower hose 1 represented in the figures contains a first connection nipple 2 at its one end, which is supposed to be connected with a sanitary fitting. This connection nipple contains a connection nut 3, which engages with an internal shoulder on a flange 4 of a lower part 5. The flange 4 of the lower part 5 is part of a hose nipple 6 that is pressed together with the inside of the hose 1. From the outside, a metallic sleeve 7 is attached to the outside of the hose 1, which, together with the nipple 6, forms the mechanical fixture of the lower part 5 at the end of the hose 1. One or several channels 8 extend through the lower part 5, through which the water can flow into the hose 1.

An upper part 9 is mounted on the lower part 5 that contains a water passage channel 10. This is disposed in the extension of the channel 8.

A sealing 11 is connected on side 1 facing away from the hose, on the upper part 9. This sealing serves to seal the hose connection.

In the upper part 9, a channel 12 is formed, which consists of a radially extending part 12a and an axial part 12b cutting the latter. The part 12b spreads out in its end section facing the lower part 5 and accommodates a ball 13 at that point. This ball 13 forms a backflow preventer, in that, when exposed to increasing pressure from the interior, it lies on a conical section of the channel 12 and closes the latter. The channel 12 leads to the radial outside of the upper part 9 and converges into the interstice between the upper part 9 and the connection nut 3. In the wall of the connection nut 3, at same height as the channel 12, one or several openings 14 are provided, from which air can be sucked in from the outside.

When water flows through the water channel 10 into the hose, low pressure is produced by the current that sucks air through the openings 14, via the channel 12 and past the ball 13 into the channel 8. Between the upper part 9 and the lower part 5, a small gap is provided so that the air can flow out of part 12b of the channel 12 into the channel 8. From there, the ventilated water now flows to the connection nipple 20 or 30 disposed at the opposite end of the hose 1.

In the embodiment according to FIG. 2, the connection nipple 20 on which a hand-held shower is firmly screwed, for instance, is formed precisely like the connection nipple of conventional technology.

In the connection nipple 30 of the embodiment according to FIG. 1, a hose nipple 6 is again formed almost identically to the hose nipple 6 at the upper end. It forms a lower part 5 of an insert by which the upper part 9 again features a backflow preventer in the form of a ball 13. In other words, the internal parts of this connection nipple 30 are similar in design to the internal parts of the opposite connection nipple 2. The upper part 9 again features a channel 12 with a section 12b for the ball 13 and a section 12a that diverges from radial outside of the upper part 9. An annular gap is provided at this point between the outside of the upper part 9 and the inside of the connection nut 3. This annular gap extends towards the end of the connection nipple, which is facing the other end of the shower hose. Also here, an annular gap 15 is formed between the metallic sleeve 7 and the inside of the connection nut 3. Through this annular gap 15, air is sucked into the channel 12.

In the embodiment according to FIG. 1, a ventilation device is therefore accommodated in both connection nipples of the shower hose, while in the simpler embodiment of FIG. 2 the ventilation device is disposed only in the one connection nipple.

The connection nipple assigned to the sanitary fitting is formed such that in both embodiments the channel 10 forms a flow limiter. The flow limiter together with the backflow preventer guarantees that with increasing flow resistance, as can occur for example in a calcified hand-held shower, no water comes out of the connections, neither through the openings 14 nor through a possibly provided annular gap between the outside of the hose and the inside of the connection nut.

What is claimed is:

1. An arrangement for ventilating shower streams, comprising:
a shower hose provided on both sides of the shower hose with one connection nipple, one said connection nipple being formed for connection to a sanitary fitting and an other said connection nipple being formed for connection of a hand-held shower, and
a ventilation device integrated inside the shower hose.

2. The arrangement according to claim 1, in which the ventilation device is disposed at the connection nipple formed for connection to the sanitary fitting.

3. The arrangement according to claim 1, in which the ventilation device is disposed at the connection nipple formed for connection to the hand-held shower.

4. The arrangement according to claim 1, in which the ventilation device has a ventilation channel that extends through a connection nut of at least one said connection nipple.

5. The arrangement according to claim 4, in which the ventilation channel converges into an outside of the connection nut.

6. The arrangement according to claim 4, in which a channel for ventilation is formed between an outside of the shower hose and an inside of the connection nut.

7. The arrangement according to claim 1, in which the ventilation device comprises a backflow preventer.

8. The arrangement according to claim 1, in which the ventilation device comprises a component unit inside at least one said connection nipple.

9. The arrangement according to claim 1, in which the ventilation arrangement comprises an upper part and a lower part, and the backflow preventer is disposed between said upper and lower parts.

10. The arrangement according to claim 9, in which the lower part comprises a single-part component of one of the connection nipples, extending inside the hose.

11. The arrangement according to claim 7, in which the backflow preventer influences only the ventilation device.

12. The arrangement according to claim 1, in which a flow limiter is disposed inside the connection nipple formed for connection to the sanitary fitting.

13-14. (canceled)

15. The arrangement according to claim 2, in which the ventilation device is disposed inside the connection nipple formed for connection to the sanitary fitting.

16. The arrangement according to claim 2, in which the ventilation device is a part of the connection nipple formed for connection to the sanitary fitting.

17. The arrangement according to claim 3, in which the ventilation device is disposed inside the connection nipple formed for connection to the hand-held shower.

18. The arrangement according to claim 3, in which the ventilation device is a part of the connection nipple formed for connection to the hand-held shower.

19. The arrangement according to claim 8, in which the component unit is inside the connection nipple.
